(19) United States
(12) Patent Application Publication
(10) Pub. No.: US 2025/0244244 A1
(43) Pub. Date: Jul. 31, 2025

(54) PREPARATION METHOD AND USE OF SURFACE-ENHANCED RAMAN SPECTROSCOPY (SERS) SUBSTRATE WITH SELF-CONFINED NANOSILVER GAPS

(71) Applicants: JINAN CUSTOMS TECHNOLOGY CENTER, Jinan City (CN); SHANDONG FIRST MEDICAL UNIVERSITY (SHANDONG ACADEMY OF MEDICAL SCIENCES), Jinan City (CN)

(72) Inventors: Le WANG, Jinan City (CN); Yongchao LAI, Jinan City (CN); Yuling ZHAO, Jinan City (CN); Lin TAO, Jinan City (CN); Yanling TIAN, Jinan City (CN)

(73) Assignees: JINAN CUSTOMS TECHNOLOGY CENTER, Jinan City (CN); SHANDONG FIRST MEDICAL UNIVERSITY (SHANDONG ACADEMY OF MEDICAL SCIENCES), Jinan City (CN)

(21) Appl. No.: 19/040,118

(22) Filed: Jan. 29, 2025

(30) Foreign Application Priority Data
Jan. 31, 2024 (CN) 202410134961.5

(51) Int. Cl. G01N 21/65; C23C 22/52; C23F 1/18

(52) U.S. Cl. CPC G01N 21/658; C23C 22/52; C23F 1/18

(57) ABSTRACT

A preparation method and use of a surface-enhanced Raman spectroscopy (SERS) substrate with self-confined nanosilver gaps are provided. The preparation method includes immersing a copper-silver alloy substrate in a FeCl₃ solution as a surface etchant and conducting etching to remove a portion of a copper-silver alloy in the copper-silver alloy substrate, subjecting the copper-silver alloy substrate to in-situ reaction to generate silver chloride on a surface, and then washing the copper-silver alloy substrate with ultrapure water to remove the surface etchant to obtain an etched copper-silver alloy substrate; and immersing the etched copper-silver alloy substrate in an aqueous ammonia and conducting reaction to remove silver chloride on the surface of the etched copper-silver alloy substrate, such that a self-confined nanogap structure is generated to obtain the SERS substrate with the self-confined nanosilver gaps.

### CROSS REFERENCE TO RELATED APPLICATION

This application claims foreign priority benefits under 35 U.S.C. § 119(a)-(d) to Chinese Patent Application No. 202410134961.5 filed on Jan. 31, 2024, the disclosure of which is hereby incorporated herein by reference in its entirety.

### TECHNICAL FIELD

The present disclosure relates to a preparation method and use of a surface-enhanced Raman spectroscopy (SERS) substrate with self-confined nanosilver gaps, belonging to the technical field of molecular recognition and nano-preparation.

### BACKGROUND

Surface-enhanced Raman spectroscopy (SERS) is one of the most sensitive spectroscopic techniques that could provide rich fingerprint information of molecular composition and conformation. The SERS has been widely used in chemical sensing, bioanalysis, food safety, environmental monitoring, clinical diagnosis, and in-situ research due to its non-destructive, label-free, and surface-sensitive characteristics at the nanoscale. This significant enhancement enables the SERS to decode target species at trace levels, even at a single-molecule level. Experiments have shown that maximum sensitivity can be achieved only when the target species are selectively adsorbed or trapped in certain specific regions (more than 80% of signal contribution in less than 1% regions), which are generally referred to as “hot spots”. Therefore, the performance and application of SERS are highly dependent on the configuration of the “hot spots”. As a result, it becomes a prerequisite for SERS research to construct a substrate with controllable and suitable “hot spots”.

Many studies have been devoted to the design and development of SERS substrates with controllable “hotspots” (generally manifested as plasma nanogaps), and their preparation methods include physical methods and chemical methods. The physical methods include nanoparticle lithography, focused ion beam lithography, electron beam lithography, and oblique shadow evaporation. The physical methods always require expensive equipment, cumbersome steps, and high preparation costs, and are in difficulty with large-scale production. The chemical methods include template method, self-assembly, electrochemistry, and displacement reaction, but a “hot spot” region of the SERS substrates prepared by the current chemical methods is generally occupied by other molecules, resulting in low SERS sensitivity of the substrates.

In conclusion, the current preparation methods still could not achieve low cost, large scale, and controllable particle gaps. Accordingly, a low-cost, large-scale, “hot spot” controllable preparation method for the SERS substrates is of great significance.

### SUMMARY

In view of the shortcomings in the prior art, especially the problem that a “hot spot” region of the current SERS substrate is occupied by other molecules, the present disclosure provides a preparation method and use of a SERS substrate with self-confined nanosilver gaps.

In the present disclosure, silver chloride generated by in-situ reaction serves as a self-confining material to control a nanogap, and then aqueous ammonia is added to remove the silver chloride by etching to release the “hot spots”. Such a process not only realizes the controllable preparation of SERS “hot spots”, but also effectively solves the problem of the “hot spot” region being occupied.

Specific technical solutions of the present disclosure are as follows:

The present disclosure provides a method for preparing a SERS substrate with self-confined nanosilver gaps, where ferric chloride is used as an etchant, a copper-silver alloy is used as a substrate, and silver chloride generated by in-situ reaction is etched and used as a self-confining material, to control a nanogap, and the silver chloride is removed by etching with an aqueous ammonia to obtain the SERS substrate with self-confined nanosilver gaps.

In the present disclosure, the SERS substrate with the self-confined nanosilver gaps has high sensitivity, desirable spatial uniformity, and excellent thermal stability. The method has advantages of rapidity, simplicity, high controllability and reproducibility, and easy scale-up production, and solves problems of difficult control of nanogaps, fragility, low reproducibility, and hotspot occupation in the existing SERS substrate preparation.

In the present disclosure, the method for preparing the SERS substrate with the self-confined nanosilver gaps described in the above technical solutions includes the following steps:
1) immersing a copper-silver alloy substrate in a FeCl₃ solution as a surface etchant and conducting etching to remove a portion of the copper-silver alloy in the copper-silver alloy substrate, subjecting the copper-silver alloy substrate to the in-situ reaction to generate the silver chloride on a surface, and then washing the copper-silver alloy substrate with ultrapure water to remove the surface etchant to obtain an etched copper-silver alloy substrate; and
2) immersing the etched copper-silver alloy substrate in the aqueous ammonia and conducting reaction to remove the silver chloride on the surface of the etched copper-silver alloy substrate, such that a self-confined nanogap structure is generated to obtain the SERS substrate with the self-confined nanosilver gaps.

In some embodiments, in step 1), the copper-silver alloy substrate has a silver mass content of 10% to 80%.

In some embodiments, in step 1), the copper-silver alloy substrate has a shape selected from the group consisting of a sheet shape and a wire shape.

In some embodiments, the FeCl₃ solution in step 1) has a concentration of 0.1 mol/L to 10 mol/L.

In some embodiments, the FeCl₃ solution in step 1) has the concentration of 0.5 mol/L to 2 mol/L.

In some embodiments, the FeCl₃ solution in step 1) has the concentration of 1 mol/L.

In some embodiments, the etching in step 1) is conducted for 1 min to 30 min.

In some embodiments, the etching in step 1) is conducted for 2 min to 10 min.

In some embodiments, the etching in step 1) is conducted for 4 min.

In some embodiments, the aqueous ammonia in step 2) has a mass concentration of 1% to 28%.

In some embodiments, the aqueous ammonia in step 2) has the mass concentration of 5% to 15%.

In some embodiments, the aqueous ammonia has the mass concentration of 14%.

In some embodiments, the reaction in step 2) is conducted for 1 min to 5 min.

The present disclosure further provides a SERS substrate with self-confined nanosilver gaps prepared by the method described in the above technical solutions.

The present disclosure further provides use of the SERS substrate with the self-confined nanosilver gaps, including:

immersing the SERS substrate with the self-confined nanosilver gaps in a modification solution and conducting self-assembling of a modification molecule on a surface of the nanosilver SERS substrate through a mercapto-silver interaction to obtain a molecule-modified SERS substrate.

In some embodiments, the modification solution is selected from the group consisting of a p-mercaptobenzoic acid (PMBA) solution, a 4-mercaptophenylboronic acid (4-MPBA) solution, and a p-aminothiophenol (PATP) solution.

In some embodiments, the modification solution is the PMBA solution, the PMBA solution has a concentration of 0.1 mmol/L to 10 mmol/L, and the immersing is conducted for 1 min to 10 min to obtain a PMBA-modified SERS substrate.

The PMBA-modified SERS substrate described in the above technical solutions is used to detect a pH value of a solution to be tested.

Embodiments of the present disclosure have the following technical features and advantages.
1. The problem of a “hot spot” region of the current SERS substrate being occupied by other molecules is solved through simple ways. Silver chloride generated by in-situ reaction serves as a self-confining material to control a nanogap, and then aqueous ammonia is added to remove the silver chloride by etching to release the “hot spot”. Such a process not only realizes the controllable preparation of SERS hotspots, but also effectively solves the problem of the “hot spot” region being occupied.
2. A SERS substrate with self-confined nanosilver gaps prepared in the present disclosure has high sensitivity, desirable spatial uniformity, and excellent thermal stability. The preparation method has advantages of rapidity, simplicity, high controllability and reproducibility, and easy scale-up production, and solves problems of difficult control of nanogaps, fragility, and low reproducibility in the existing SERS substrate preparation.

### BRIEF DESCRIPTION OF THE DRAWINGS

FIG. 1 shows a schematic diagram of the preparation process of the SERS substrate with the self-confined nanosilver gaps according to an embodiment of the present disclosure;

FIGS. 2A-2I show X-ray diffraction (XRD), SERS spectra, scanning electron microscope (SEM), and energy dispersive spectrum (EDS) diagrams during the preparation process of the SERS substrate with the self-confined nanosilver gaps according to an embodiment of the present disclosure; where FIG. 2A shows the XRD of a substrate surface at different stages in etching (Step 1: Ag-Cu alloy; Step 2: Ag-AgCl; Step 3: 3D Ag substrates, corresponding to FIG. 1); FIG. 2B shows the SERS spectrum of PATP on a copper-silver alloy at different stages; FIG. 2C shows the spectra of SERS substrates modified with different signal molecules (PATP, 4-MPBA, and PMBA); FIGS. 2D to 2F show SEM images of the substrate surface at different stages of the etching (FIG. 2D corresponds to Step 1: Ag-Cu alloy; FIG. 2E corresponds to Step 2: Ag-AgCl; FIG. 2F corresponds to Step3: 3D Ag substrates, corresponding to FIG. 1); FIGS. 2G to 2I show EDS diagrams of the substrate surface at different stages of the etching (FIG. 2G corresponds to Step 1: Ag-Cu alloy; and FIG. 2H corresponds to Step 2: Ag-AgCl; FIG. 2I corresponds to Step 3: 3D Ag substrates, corresponding to FIG. 1);

FIGS. 3A-3D show performance diagrams of stability and uniformity of the SERS substrate with the self-confined nanosilver gaps according to an embodiment of the present disclosure, where FIG. 3A shows temporal stability, FIG. 3B shows spatial uniformity, FIG. 3C shows laser continuous irradiation stability, and FIG. 3D shows laser continuous irradiation stability in a pH test; and

FIGS. 4A-4B show a pH response of the SERS substrate with the self-confined nanosilver gaps according to an embodiment of the present disclosure, where FIG. 4A shows a pH response curve, and FIG. 4B shows SERS spectra of a PMBA-modified SERS substrate in different pH solutions.

### DETAILED DESCRIPTION

To make those skilled in the art better understand the present disclosure, the following clearly and completely describes the technical solutions in the embodiments of the present disclosure with reference to the drawings in the embodiments of the present disclosure. Apparently, the described embodiments are merely some rather than all of the embodiments of the present disclosure. All other embodiments obtained by persons of ordinary skill in the art based on the embodiments of the present disclosure without creative efforts shall fall within the scope of the present disclosure.

### Example 1

A method for preparing a SERS substrate with self-confined nanosilver gaps was performed by the following steps.
1) A copper-silver alloy substrate with a silver content of 50% was immersed in a 1 mol/L FeCl₃ solution as a surface etchant, and subjected to etching for 4 min to remove a portion of a copper-silver alloy in the copper-silver alloy substrate. The copper-silver alloy substrate was subjected to in-situ reaction to generate silver chloride on a surface, and then the copper-silver alloy substrate was washed with ultrapure water to remove the surface etchant to obtain an etched copper-silver alloy substrate.
2) The etched copper-silver alloy substrate was immersed in aqueous ammonia with a mass concentration of 14%, and subjected to reaction for 2 min to remove the silver chloride on the surface of the etched copper-silver alloy substrate, such that a self-confined nanogap structure was generated to obtain the SERS substrate with the self-confined nanosilver gaps.

### Example 2

Preparation of a PMBA-modified SERS substrate was performed by the following steps.

The SERS substrate with the self-confined nanosilver gaps prepared in Example 1 was immersed in a 2 mmol/L PMBA solution for 5 min, and subjected to self-assembling of a modification molecule on a surface of the nanosilver SERS substrate through a mercapto-silver interaction to obtain a PMBA-modified SERS substrate, which was used to test a pH value of a solution to be tested.

### Test Example 1

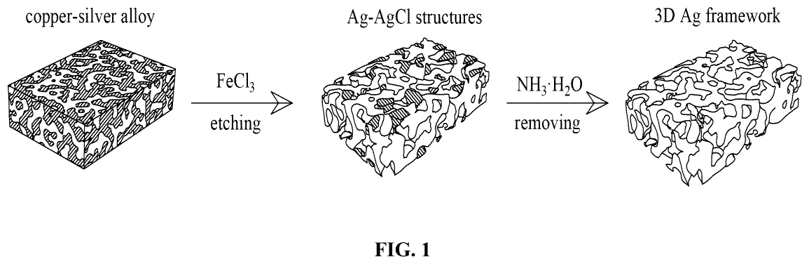

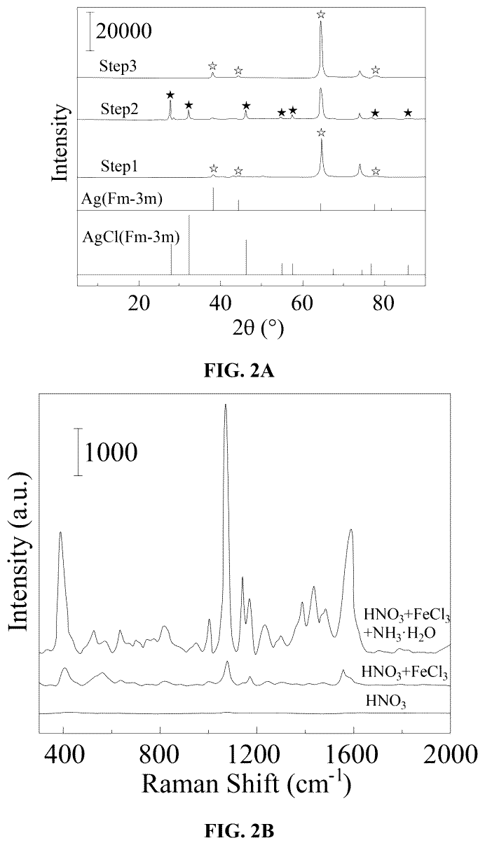

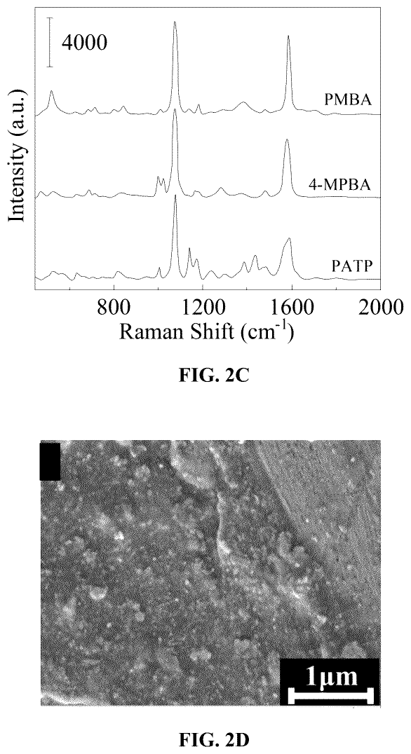

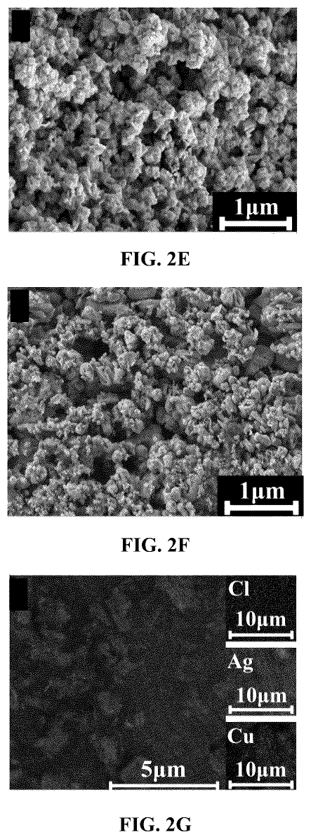

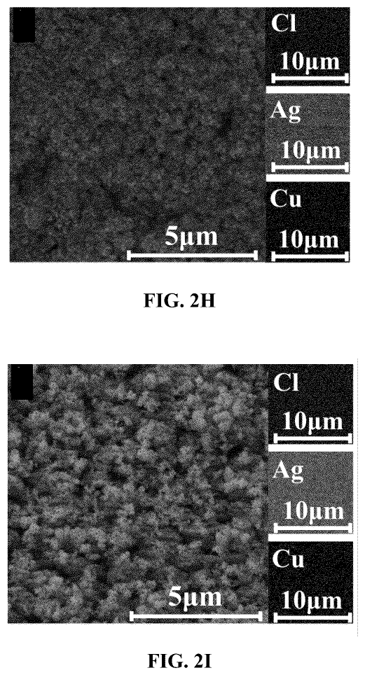

1. In the present disclosure, FIG. 1 shows a schematic diagram of the preparation process of the SERS substrate with the self-confined nanosilver gaps according to an embodiment of the present disclosure. FIGS. 2A-2I show XRD, SERS spectra, SEM, and EDS diagrams during the preparation process of the SERS substrate with the self-confined nanosilver gaps according to Example 1.

As shown in FIG. 1, Cu and Ag are randomly distributed in a Cu-Ag alloy (Step 1); after adding a FeCl₃ etchant, Cu in the Cu-Ag alloy is gradually etched away, leaving an Ag structure and a small amount of AgCl generated in situ (Step 2); the in situ generated AgCl is then washed away with aqueous ammonia to obtain the SERS substrate with the self-confined nanosilver gaps (Step 3).

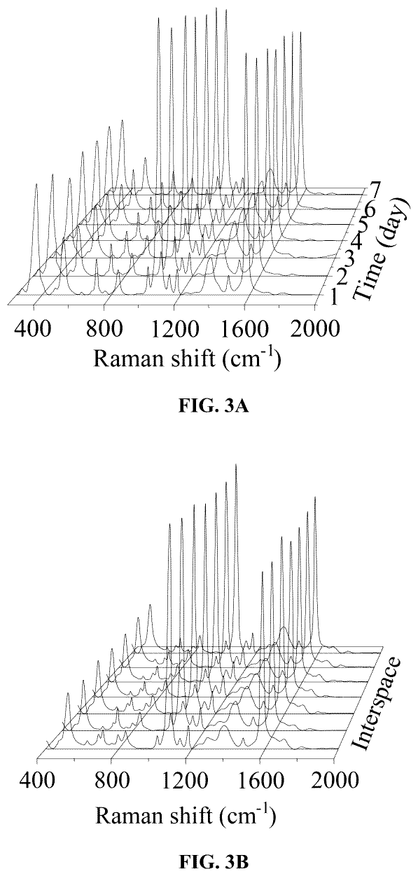

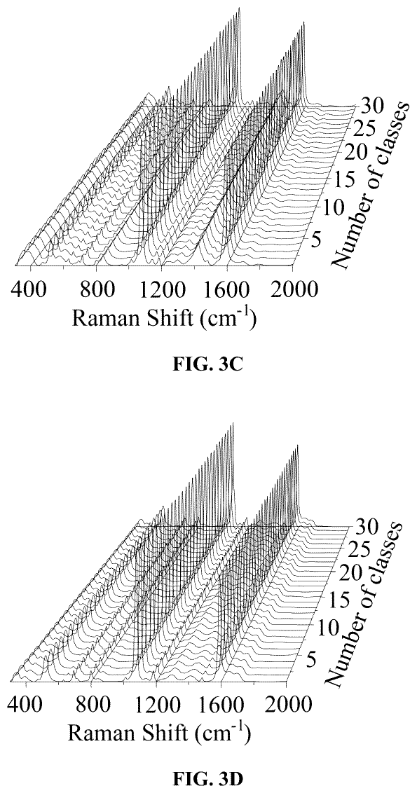

The XRD of FIG. 2A clearly shows phase changes during the process. Under an action of the FeCl₃ etchant, a Cu phase is reduced and AgCl appears. After washing with aqueous ammonia, the AgCl disappears. By using PATP as a probe molecule, SERS enhancement ability of the copper-silver alloy at different etching stages was investigated, as shown in FIG. 2B, the Cu-Ag alloy that only used HNO₃ to remove a surface oxide layer has almost no SERS enhancement effect, the Cu-Ag alloy after FeCl₃ etching shows considerable SERS enhancement ability, and the SERS enhancement ability of the Cu-Ag alloy after aqueous ammonia cleaning is further greatly improved. In addition to the PATP, the SERS substrate with the self-confined nanosilver gaps has excellent enhancement effects on other Raman probe molecules such as PMBA and 4-MPBA (FIG. 2C). FIG. 2D to 2I show SEM images and EDS diagrams of a substrate surface at different stages of the etching, which clearly reveals surface morphology and element distribution evolution of the substrate at the different etching stages.
2. Using the PMBA as a Raman probe, multiple analytical performance indicators of the SERS substrate with the self-confined nanosilver gaps were investigated (FIGS. 3A-3D). FIG. 3A shows temporal stability: within one week, a portable Raman spectrometer (laser power of 20 mW) was used to detect PMBA-modified SERS substrates from the same batch, and a relative standard deviation (RSD) was 7.08% calculated based on a characteristic peak of the PMBA at 1,073 cm⁻¹ in a continuous measurement for 7 d. FIG. 3B shows spatial uniformity: SERS signal spectrum of the PMBA was randomly measured at different positions on one PMBA-modified SERS substrate, and a RSD value was 2.47% calculated based on a characteristic peak of the PMBA at 1,073 cm⁻¹. FIG. 3C shows laser continuous irradiation stability: a same part of the SERS substrate was continuously irradiated for 5 min using the portable Raman spectrometer (laser power of 20 mW), and the SERS spectrum was collected every 10 s, and the RSD was only 0.54% calculated based on a characteristic peak of the PMBA at 1,073 cm¹. FIG. 3D shows laser continuous irradiation stability in a pH test: based on a test in FIG. 3C, the substrate was placed in a solution of the pH test, and 30 consecutive SERS spectra were collected, and the RSD was only 0.88% calculated based on a characteristic peak of the PMBA at 1,073 cm⁻¹. The above multiple analytical performance indicators show that the SERS substrate has desirable temporal stability, spatial uniformity, and thermal stability under continuous laser irradiation.

### Test Example 2

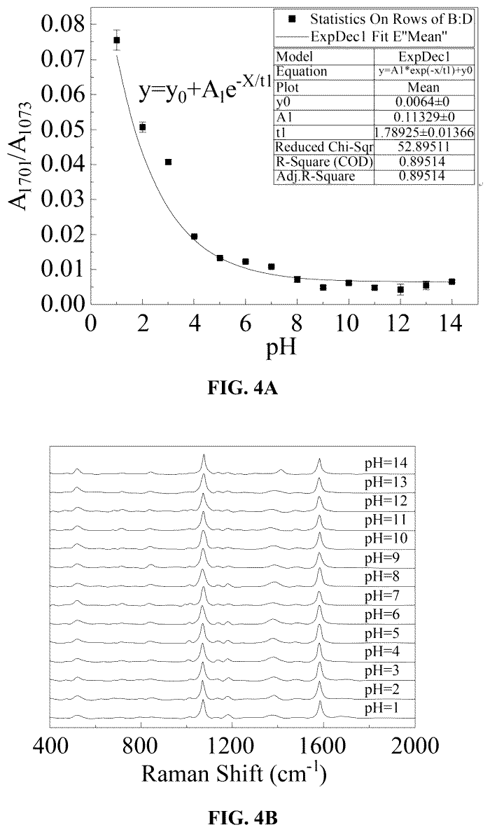

The PMBA-modified SERS substrate prepared in Example 2 was placed in different pH standard solutions, which were prepared with H₂SO₄ (98%), NaOH, and ultrapure water, and calibrated with a pH meter, with pH=1-14. After immersing for 2 min, the PMBA-modified SERS substrate was taken out and detected by Raman spectrometer, and SERS spectra and pH response curves are shown in FIGS. 4A-4B. FIG. 4B shows the SERS spectra of the PMBA-modified SERS substrate in different pH solutions. Due to response of carboxylate ions to hydrogen ion concentrations, the SERS spectrum of PMBA shows obvious pH dependence. By using a Raman peak intensity at 1,073 cm⁻¹ as an internal standard and plotting a ratio of the Raman peak intensities at 1,701 cm⁻¹ to 1,073 cm⁻¹ against a pH value of a solution to be tested, a pH response curve of the substrate was obtained, as shown in FIG. 4A.

### Example 3

A method for preparing a SERS substrate with self-confined nanosilver gaps was performed by the following steps.
1) A copper-silver alloy substrate with a silver content of 60% was immersed in a 0.5 mol/L FeCl₃ solution as a surface etchant, and subjected to etching for 12 min to remove a portion of a copper-silver alloy in the copper-silver alloy substrate. The copper-silver alloy substrate was subjected to in-situ reaction to generate silver chloride on a surface, and then the copper-silver alloy substrate was washed with ultrapure water to remove the surface etchant to obtain an etched copper-silver alloy substrate.
2) The etched copper-silver alloy substrate was immersed in aqueous ammonia with a mass concentration of 14%, and subjected to reaction for 5 min to remove the silver chloride on the surface of the etched copper-silver alloy substrate, such that a self-confined nanogap structure was generated to obtain the SERS substrate with the self-confined nanosilver gaps.

### Example 4

A method for preparing a SERS substrate with self-confined nanosilver gaps was performed by the following steps.
1) A copper-silver alloy substrate with a silver content of 70% was immersed in a 2 mol/L FeCl₃ solution as a surface etchant, and subjected to etching for 5 min to remove a portion of a copper-silver alloy in the copper-silver alloy substrate. The copper-silver alloy substrate was subjected to in-situ reaction to generate silver chloride on a surface, and then the copper-silver alloy substrate was washed with ultrapure water to remove the surface etchant to obtain an etched copper-silver alloy substrate.
2) The etched copper-silver alloy substrate was immersed in aqueous ammonia with a mass concentration of 28%, and subjected to reaction for 5 min to remove the silver chloride on the surface of the etched copper-silver alloy substrate, such that a self-confined nanogap structure was generated to obtain the SERS substrate with the self-confined nanosilver gaps.

### Example 5

A method for preparing a SERS substrate with self-confined nanosilver gaps was performed by the following steps.
1) A copper-silver alloy substrate with a silver content of 40% was immersed in a 0.6 mol/L FeCl₃ solution as a surface etchant, and subjected to etching for 8 min to remove a portion of a copper-silver alloy in the copper-silver alloy substrate. The copper-silver alloy substrate was subjected to in-situ reaction to generate silver chloride on a surface, and then the copper-silver alloy substrate was washed with ultrapure water to remove the surface etchant to obtain an etched copper-silver alloy substrate.
2) The etched copper-silver alloy substrate was immersed in aqueous ammonia with a mass concentration of 20%, and subjected to reaction for 5 min to remove the silver chloride on the surface of the etched copper-silver alloy substrate, such that a self-confined nanogap structure was generated to obtain the SERS substrate with the self-confined nanosilver gaps.

What is claimed is:

1. A method for preparing a surface-enhanced Raman spectroscopy (SERS) substrate with self-confined nanosilver gaps, wherein ferric chloride is used as an etchant, a copper-silver alloy is used as a substrate, and silver chloride generated by in-situ reaction is etched and used as a self-confining material, to control a nanogap, and the silver chloride is removed by etching with an aqueous ammonia to obtain the SERS substrate with the self-confined nanosilver gaps.

2. The method of claim 1, comprising the following steps:
step 1) immersing a copper-silver alloy substrate in a FeCl₃ solution as a surface etchant and conducting etching to remove a portion of the copper-silver alloy in the copper-silver alloy substrate, subjecting the copper-silver alloy substrate to the in-situ reaction to generate the silver chloride on a surface, and then washing the copper-silver alloy substrate with ultrapure water to remove the surface etchant to obtain an etched copper-silver alloy substrate; and
step 2) immersing the etched copper-silver alloy substrate in the aqueous ammonia and conducting reaction to remove the silver chloride on the surface of the etched copper-silver alloy substrate, such that a self-confined nanogap structure is generated to obtain the SERS substrate with the self-confined nanosilver gaps.

3. The method of claim 2, wherein in step 1), a copper-silver alloy substrate has a silver mass content of 10% to 80%, and the copper-silver alloy substrate has a shape selected from the group consisting of a sheet shape and a wire shape.

4. The method of claim 2, wherein a FeCl₃ solution in step 1) has a concentration of 0.1 mol/L to 10 mol/L; and the etching is conducted for 1 min to 30 min.

5. The method of claim 2, wherein the aqueous ammonia in step 2) has a mass concentration of 1% to 28%.

6. The method of claim 2, wherein a reaction in step 2) is conducted for 1 min to 5 min.

7. A SERS substrate with self-confined nanosilver gaps prepared by the method of claim 1.

8. A method of using of the SERS substrate with the self-confined nanosilver gaps of claim 7, comprising:
immersing the SERS substrate with the self-confined nanosilver gaps in a modification solution and conducting self-assembling of a modification molecule on a surface of the nanosilver SERS substrate through a mercapto-silver interaction to obtain a molecule-modified SERS substrate.

9. The method of claim 8, wherein the modification solution is selected from the group consisting of a p-mercaptobenzoic acid (PMBA) solution, a 4-mercaptophenylboronic acid (4-MPBA) solution, and a p-aminothiophenol (PATP) solution.

10. The method of claim 8, wherein the modification solution is a PMBA solution, the PMBA solution has a concentration of 0.1 mmol/L to 10 mmol/L, and the immersing is conducted for 1 min to 10 min to obtain a PMBA-modified SERS substrate.

11. The method of claim 4, wherein the FeCl3 solution in step 1) has the concentration of 0.5 mol/L to 2 mol/L.

12. The method of claim 4, wherein the etching is conducted for 2 min to 10 min.

13. The method of claim 5, wherein the aqueous ammonia in step 2) has the mass concentration of 5% to 15%.

14. The SERS substrate with the self-confined nanosilver gaps of claim 7, wherein the SERS substrate with self-confined nanosilver gaps prepared by the following steps:
step 1) immersing a copper-silver alloy substrate in a FeCl₃ solution as a surface etchant and conducting etching to remove a portion of the copper-silver alloy in the copper-silver alloy substrate, subjecting the copper-silver alloy substrate to the in-situ reaction to generate the silver chloride on a surface, and then washing the copper-silver alloy substrate with ultrapure water to remove the surface etchant to obtain an etched copper-silver alloy substrate; and
step 2) immersing the etched copper-silver alloy substrate in the aqueous ammonia and conducting reaction to remove the silver chloride on the surface of the etched copper-silver alloy substrate, such that a self-confined nanogap structure is generated to obtain the SERS substrate with the self-confined nanosilver gaps.

15. The SERS substrate with self-confined nanosilver gaps of claim 14, wherein in step 1), a copper-silver alloy substrate has a silver mass content of 10% to 80%, and the copper-silver alloy substrate has a shape selected from the group consisting of a sheet shape and a wire shape.

16. The SERS substrate with self-confined nanosilver gaps of claim 14, wherein a FeCl₃ solution in step 1) has a concentration of 0.1 mol/L to 10 mol/L; and the etching is conducted for 1 min to 30 min.

17. The SERS substrate with self-confined nanosilver gaps of claim 14, wherein the aqueous ammonia in step 2) has a mass concentration of 1% to 28%.

18. The SERS substrate with self-confined nanosilver gaps of claim 14, wherein a reaction in step 2) is conducted for 1 min to 5 min.

19. The SERS substrate with self-confined nanosilver gaps of claim 16, wherein the FeCl₃ solution in step 1) has the concentration of 0.5 mol/L to 2 mol/L.

20. The SERS substrate with self-confined nanosilver gaps of claim 16. wherein the etching is conducted for 2 min to 10 min.
